(19) United States
(12) Patent Application Publication
(10) Pub. No.: US 2025/0256311 A1
(43) Pub. Date: Aug. 14, 2025

(54) METHOD OF RECOVERING CATALYST MATERIAL FROM A MEMBRANE ELECTRODE ASSEMBLY FROM WATER ELECTROLYSIS

(71) Applicant: Siemens Energy Global GmbH & Co. KG, München (DE)

(72) Inventors: Christian Reller, Minden (DE); Yashar Musayev, Nürnberg (DE)

(21) Appl. No.: 18/855,093

(22) PCT Filed: Dec. 27, 2022
(86) PCT No.: PCT/EP2022/087861

§ 371 Date: Oct. 8, 2024

(30) Foreign Application Priority Data
Apr. 11, 2022 (DE) 10 2022 203 608.5

(51) Int. Cl. B09B 3/70; B09B 3/35; B09B 3/40; B09B 101/15; B09B 101/95; C25B 11/081

(52) U.S. Cl. CPC B09B 3/70; B09B 3/35; B09B 3/40; B09B 2101/15; B09B 2101/95; C25B 11/081

(57) ABSTRACT

The invention relates to a method of recovering catalyst material from a membrane electrode assembly from water electrolysis, including the steps of providing a membrane electrode assembly having a membrane coated with a metallic catalyst material, comminuting the membrane electrode assembly, pyrolytically decomposing the comminuted membrane electrode assembly to obtain a solid pyrolysis product as residue, dissolving the solid pyrolysis product in a mixture of concentrated hydrochloric acid and concentrated nitric acid, removing the nitrates by heating the solution to 100° C. to 110° C.,—filtering the insoluble residue, and drying the insoluble residue at a drying temperature (TD) to recover the metallic catalyst material. The method may be employed for the recycling of a membrane electrode assembly from PEM water electrolysis, where iridium as metallic catalyst material is recovered.

### BACKGROUND

Method of recovering catalyst material from a membrane electrode assembly from water electrolysis

The invention relates to a method for recovering catalyst material from a membrane electrode assembly from water electrolysis. For said method, a used membrane electrode assembly comprising a membrane coated with a metallic catalyst material is provided.

Hydrogen is an important substance that is used in numerous applications in industry and technology. As a general rule, hydrogen occurs on Earth only in a bound state. One of those substances that contains hydrogen in the bound state is water. Hydrogen can in addition also be used as an energy store, particularly in order to store electrical energy generated by means of regenerative energy generation methods for subsequent applications.

An important process for obtaining hydrogen is the electrolysis of water, in particular using electrical energy. Hydrogen can in this case serve inter alia as an energy store, by using it for example as a fuel in order to provide a more constant supply of electrical energy from renewable energies in particular, for example wind power, photovoltaics or the like. It is however also possible to use hydrogen for other processes in which a fuel or a reducing agent is needed. The hydrogen obtained in electrolysis can thus for example be used industrially or electrical energy can be recovered electrochemically using fuel cells.

The separation of water into its chemical constituents hydrogen and oxygen can be carried out by means of suitable electrolysis cells. For this purpose, these can take the form of what are known as polymer electrolyte membrane electrolysis cells. Usually provided in an electrolysis cell of this kind is a membrane that has a catalyst layer on each of the surfaces facing away from one another. The catalyst layers are usually adjoined by respective gas diffusion layers, which in turn are adjoined by respective electrically conductive contact plates, occasionally also referred to as bipolar plates, which are used inter alia for electrical contacting. At the same time, the contact plates, or the bipolar plates, are preferably also designed so as to be able to permit the required mass transfer when operated in the correct manner during the electrolysis in the electrolysis cell. For this purpose, appropriate channels can be provided for supplying a respectively suitable electrolyte and for discharging the reaction products of the electrolysis, namely hydrogen gas and oxygen gas. The gas diffusion layer generally provides electrical conductivity in order to electrically couple the contact plates and the catalyst layers to one another. This makes it possible to realize the desired electrochemical reaction in the region of the catalyst layers.

When the electrolysis reaction is a reaction in the alkaline range, an anion-exchange membrane (AEM) is provided as the membrane. On the other hand, when the electrolysis reaction takes place in the acid range, a proton-exchange membrane (PEM) is provided instead.

Hydrogen is produced from water via the electrolysis process. This is an electrochemical operation in which water is separated into its chemical constituents oxygen and hydrogen. Depending on the mode of operation, the electrochemical cell reactions can be described and differentiated as follows:

### Alkaline Electrolysis:

Anode electrode 4OH−→2H2O+O2+4e− (1)

Cathode electrode 2H2O+2e−→2OH−+H2 (2)

### Acidic Electrolysis:

Anode electrode 2H2O→4H++O2+4e− (1)

Cathode electrode 4H++4e−→H2 (2)

In a polymer electrolyte membrane electrolysis, the respective two subreactions are spatially separated by an ion-conducting membrane. In an electrolysis in the alkaline range it is an anion-exchange membrane (AEM) that is provided here, whereas in an electrolysis in an acidic environment a proton-exchange membrane (PEM) is provided. The construction of the membrane electrode assembly (MEA) can however in both cases be fundamentally comparable.

A core element of such a polymer electrolyte membrane electrolysis cell is usually formed by a membrane electrode assembly (MEA). The membrane electrode assembly comprises at least the membrane, which is usually coated with a layer of a respective catalyst material both on the anode side and on the cathode side, on two surfaces facing away from one another. The respective cell reaction of the electrolysis proceeds in the region of the layer formed by the respective catalyst material. During operation in the correct manner, electrons are conducted away to the contact plates via the respective catalyst material and a support structure that can be formed by the gas diffusion layer or can provide said layer. For this reason, it is desirable for the catalyst layers to have high electrical conductivity.

In addition to electrons, hydroxide anions OH− are formed in the reaction in the alkaline range and protons H+ are formed in operation in the acid range, which are moved through the respective membrane as charge carriers. In this regard, it is therefore desirable for the structure of the layers of the respective catalyst materials to have good conductivity in order for the respective ions to be transported to the membrane or from the membrane to the respective catalyst materials. It is accordingly a technical challenge to provide good ionic bonding of the catalyst material to the membrane while at the same time ensuring the catalyst material has good electrical conductivity.

In the prior art, membrane electrode assemblies/units are produced by providing the catalyst materials in the form of a paste that is applied either directly to the appropriate surface of the membrane or to the appropriate surface of a substrate. The paste-like or pasty catalyst material consists here of the catalyst material itself, an ionomer, a polymeric binder, and a solvent. After application, the solvent is usually thermally removed/thermally expelled by compressing the layers of catalyst material with the membrane at a high temperature usually greater than 100° C. This is intended to ensure ionic contact of the ionomer and the catalyst material with the membrane.

A membrane electrode assembly comprises a membrane that has a respective catalyst material on two surfaces facing away from one another. In many applications, particularly in PEM water electrolysis, such assemblies employ very costly, and accordingly very rare, precious metals as catalyst material. Thus, in addition to environmental perspectives in favor of recycling management, there is enormous economic interest in reprocessing used membrane electrode assemblies in order to recover valuable metallic catalyst material and, where necessary, to use them in a new membrane electrode assembly or to supply them to other applications.

### SUMMARY

The object of the invention is to specify a method for recovering catalyst material from a membrane electrode assembly that permits a particularly easy and cost-effective recovery of catalyst material.

The object is in accordance with the invention achieved by a method for recovering catalyst material from a membrane electrode assembly from water electrolysis, comprising the steps of providing a membrane electrode assembly comprising a membrane coated with a metallic catalyst material, comminuting the membrane electrode assembly, pyrolytically breaking down the comminuted membrane electrode assembly to obtain a solid pyrolysis product as residue, dissolving the solid pyrolysis product in a mixture of concentrated hydrochloric acid and concentrated nitric acid, removing the nitrates by heating the solution to 100°° C. to 110° C., filtering the insoluble residue, and drying the insoluble residue at a drying temperature to recover the metallic catalyst material.

The invention already assumes the general basic endeavor that recycling makes a considerable contribution to protecting the environment. Recycling means sustainability, since raw material resources do not last forever. And recycling is hard cash, since metallic catalyst materials are often precious metals that are far too valuable not to recycle. Moreover, the large-scale industrial exploitation of electrolyzers for water electrolysis can be expected to lead to a rapid growth in demand for membrane electrode assemblies, which in turn will place demands on the economic viability of known recycling processes increasingly from both cost and efficiency viewpoints.

For instance, although there are multiple descriptions in the scientific literature of reprocessing and separation methods on a laboratory scale, the economic and industrial implementation thereof is overly complex in terms of process procedures and is consequently very cost-intensive. There is therefore a need for an easy and cost-effective recovery of metallic catalyst materials, which the invention has recognized.

With the procedure of the invention, the recovery in particular of metallic catalyst material, and of precious metals in particular, becomes possible with high efficiency. The catalyst material on the membrane of a membrane electrode assembly can for example on the anode side comprise one or more of the following substances, namely nickel-aluminum, nickel-zinc, cobalt-aluminum, cobalt-iron, nickel-iron, nickel-iron-vanadium, nickel-cobalt, nickel-molybdenum, nickel-iron-double layered hydroxide, nickel-iron-cobalt, iridium, ruthenium oxide, nickel hydroxide, nickel oxide, and nickel

The catalyst material on the membrane can for example on the cathode side comprise one or more of the following substances, namely nickel, nickel-molybdenum on carbon black, nickel-molybdenum, nickel-platinum, platinum, nickel on carbon black, nickel phosphate, and nickel-vanadium.

There first takes place a mechanical comminution of a used membrane electrode assembly to a predetermined degree of comminution. The economic and technical service life of the ion-conducting membrane is limited by various influencing factors. For instance, degradation effects on the membrane have been described that damage the membrane material and impair the function. The harsh electrochemical conditions that can always develop in any water electrolysis can result in the formation of small amounts of H2O2 and OH radicals in the electrolyzer, for example in the region of the cells. It is well known that such species can chemically attack the membrane material of PEM electrolyzers, such breakdown being accompanied by the release of fluorides as degradation products. This is a consequence of the membrane having a fluorine component and being made, for example, of a PFSA (perfluorosulfonic acid). The membrane is a particularly important element for the functioning of the electrolysis cells in PEM electrolysis, consequently the service life thereof and its limitation by degradation effects attracts much attention, including from economic viewpoints in particular. The metallic catalyst material is on the other hand practically unconsumed, with no tendency to degradation, which makes reprocessing and recovery highly advantageous.

The invention is characterized by a considerably simplified process that manages with few separation operations for separating precious metal from high-value catalyst material, as has surprisingly been found.

Comminution of the membrane electrode assembly is followed first of all by a pyrolysis. The pyrolysis or pyrolytic breakdown describes various thermochemical transformation processes in which organic compounds are cleaved at high temperatures and largely with the exclusion of oxygen. The high temperatures result in the cleavage of some chemical bonds in the starting materials, with the oxygen deficit preventing complete combustion. A wide range of products is formed. The residue obtained in the method of the invention is a solid pyrolysis product, an ash, that is present in a corresponding granularity or particle size and comprises the metallic catalyst material. Present in the ash is a mixture of the catalyst material used on the anode side and the catalyst material used on the cathode side.

The pyrolysis generally gives rise to complex product mixtures of solid, liquid, and gaseous products, the exact proportions depending on the specific conditions and the input material. As a generalization it can be stated that higher temperatures and longer pyrolysis times result in more gaseous products being obtained, with lower temperatures and shorter times favoring more liquid products. When polymers are pyrolyzed, the corresponding monomers are often obtained as product. The products can be utilized either energetically, as secondary energy sources, since they have high energy contents, or they can be used further as feedstocks for obtaining individual chemicals therefrom. In the present method it is preferable to use higher temperatures for the pyrolytic cleavage of the comminuted membrane electrode unit.

In the pyrolysis, the membrane passes into the gaseous state completely such that that there are no hydrocarbon residues remaining in the solid pyrolysis product, the ash.

There now follows a dissolution in aqua regia of the solid pyrolysis products, the ash residue, resulting in the formation of a solution. Aqua regia consists of a mixture of hydrochloric acid HCl and nitric acid HNO3 in a ratio of 3:1. The procedure for the process of the invention essentially differentiates here between catalyst material that is insoluble in aqua regia and catalyst material that dissolves in aqua regia, and successively separates each of them in just two subsequent steps. The solution is first heated to 100° C. to 110° C., resulting in the thermal expulsion of the nitrates from the solution. This step thus comprises a removal of precious metal nitrates and reprocessing of the catalyst material that has dissolved in the aqua regia and that had preferably been used on the cathode side of the membrane electrode assembly and been applied to the intact membrane. These are precious metals soluble in aqua regia, such as preferably platinum or binary platinum alloys, for example nickel-platinum, that are used as catalyst. Thus, the solution left behind after this process step advantageously still contains the metallic catalyst material insoluble in aqua regia that had preferably been used on the anode side of the membrane electrode assembly, for example iridium. This solid constituent can now in the filtration step be very advantageously and easily removed and thus separated. This provides an insoluble residue in which high-value metallic catalyst material already predominates.

As a further step, the residue is finally dried at a drying temperature for a drying time such that all liquid constituents and any gaseous constituents still present in the residue are removed or thermally expelled. A solid residue is now advantageously recovered that comprises the insoluble metallic catalyst material or already consists predominantly thereof. The metallic catalyst material can be purified directly and supplied for reuse, for instance applied onto a new membrane as anode-side catalyst material.

The method described herein permits the particularly advantageous direct recovery of valuable anodic precious metal catalysts (OER catalysts) from the metal electrode assembly from PEM water electrolysis without having to dissolve, melt or rework said catalysts. In the method described herein the number of process steps is significantly reduced and loss pathways associated with a large number of separation steps are avoided. From an economic perspective, further, high reworking costs associated with separation (separation process) are averted, as are production costs for the precipitation of new catalyst material.

The cathodic catalyst material can advantageously also be supplied for reuse here without great outlay. The process procedure differentiates here solely between catalyst material that is insoluble in aqua regia and catalyst material that dissolves in aqua regia, and efficiently separates each of these materials in an individual process step.

The procedure for the process of the invention is both technically and economically superior to previously described industrial approaches. These previous approaches are based for example on a pyrolysis of the membrane, dissolution of the catalysts or removal through complete dissolution of the catalyst constituents in a solvent. When insoluble metallic catalyst material is used for this purpose, there is no need for a potential dissolution in aqua regia, since the insoluble anodic precious metal catalyst material does not dissolve in aqua regia. The subsequent separation operations necessary to separate the precious metal would therefore involve complex and loss-associated Na2O2 oxidation melt processes and other steps in order to transform metallic catalyst material into, for example, a soluble oxide of the metallic catalyst material. The invention specifically avoids the loss-associated path of reprocessing the catalyst material by means of transformation processes via soluble intermediate products. From a process perspective, the numerous process steps involved in the recovery of metallic catalyst materials in the highest possible purity give rise to high process costs. Moreover, the corrosiveness of the chemicals used necessitates generally costly reactor linings. This is avoided by the invention.

It has advantageously been found that the pyrolysis step does not result in any noteworthy coarsening of the particle size being able to be detected by comparison with fresh catalyst. Furthermore, it was surprisingly found that the metallic catalyst material is after the drying step already present in adequate purity and good quality such that it can be used directly for the production of a new membrane electrode assembly. The method proposed herein thus permits a reduction in the established process steps to an extent sufficient to achieve significant cost and time savings in process procedures. By virtue of the proposed process it is thus possible to boost precious metal recovery in particular.

In one embodiment of the method, the insoluble residue is ground such that a median particle size of 10 μm to 80 μm, in particular of 20 μm to 50 μm, is achieved.

After drying the insoluble residue at the drying temperature, the metallic catalyst material is already present in the form of solid particles. It may be advantageous to subject this residue to a grinding process until a desired particle size distribution, in particular a median particle size, is achieved for the metallic catalyst material. The grinding process allows the surface-to-volume ratio of the catalyst particles to be adjusted to a more favorable value, which is advantageous for a subsequent process of coating a new membrane with the recovered catalyst material and for high catalytic efficiency while keeping material usage in a membrane electrode unit as low as possible.

The pyrolysis step is preferably carried out at a pyrolysis temperature of from 600°° C. to 1000° C., in particular from 700° C. to 900°° C. Thus a high-temperature pyrolysis is carried out such that the constituents of the membrane, as a result of the pyrolysis, pass over into gaseous products and do not remain in the solid pyrolysis product, or in the residue, but are expelled.

In one embodiment of the method, the solid pyrolysis product is dissolved in aqua regia at a temperature of from 70° C. to 90° C., in particular at a temperature of 80° C., with the temperature maintained during dissolution for between 3 hours to 5 hours, in particular for 4 hours. A pyrolysis temperature of 80° C. with a contact time of 4 hours was found to be particularly advantageous in order to bring about a good dissolution result for the soluble constituents in the solid pyrolysis product. This can however vary within certain limits from one batch to the next, with lower temperatures needing a longer contact time and vice versa.

In exemplary embodiments, the heating in the mixture of hydrochloric acid and nitric acid expels and removes dissolved metallic constituents, with the insoluble residue being obtained. As a result of the dissolution process in aqua regia, the soluble constituents are present for example in the form of metal salts, in particular in the form of metal nitrates. These are expelled from the solid residue by heating the solution to 100° C. to 110° C., i.e. they escape from the residue by outgassing or vaporization. Advantageously, these species are collected for a complete recycling process of the soluble species too.

In one embodiment of the method, platinum is removed and recovered as dissolved metal constituent. Platinum can be used advantageously as a metallic catalyst material on the cathode side of the membrane of a membrane electrode unit. Since platinum is a costly precious metal, recovery makes economic sense. It is also possible for a binary metal containing platinum, for example platinum-nickel, to be used as a soluble metallic constituent and to be subjected to the recycling process. In a membrane electrode unit, platinum or platinum-nickel is particularly advantageous as catalyst material on the cathode side of the membrane, particularly in the case of applications in PEM electrolysis.

In one embodiment of the method, iridium is recovered as metallic catalyst material. The insoluble constituent in the residue is in this case preferably iridium, which is not attacked by aqua regia. The iridium is here advantageously already presently obtained in the residue in the form of metal or metal particles of good quality and purity, preferably after washing/rinsing the filter. Thus, the iridium thereby obtained can be applied directly as catalyst material to the anode side of a new ion-conducting membrane and is reusable for electrolysis purposes in new membrane electrode assemblies.

In exemplary embodiments, the iridium is recovered in the form of solid iridium black, an iridium purity of 97% to 99.5%, in particular of 98% to 99.3%, being achieved.

The iridium black is already present in an appropriate particle size, it being optionally possible for it to undergo a grinding process for tailoring the particle size to use of the catalyst in a membrane electrode assembly. The iridium is present here as iridium black in high purity, so that the prior tailoring of the particle size allows it to be directly reused for the production of new membrane electrode assemblies. Iridium black is a solid with a metallic black color.

In exemplary embodiments, a yield of recovered iridium black of greater than 80%, in particular of between 92% and 96%, based on the amount of iridium originally present, is achieved.

By virtue of the simplified process procedure with essentially just in each case one separation process and treatment of the soluble and insoluble metallic constituents, hardly any losses of material are seen; what is achieved instead is an almost closed and loss-free recycling process for the catalyst materials. In particular, the iridium catalyst material insoluble in aqua regia does not require any further and-from a process perspective-laborious transformation processes that would inevitably result in material losses of iridium in the precious metal separation process.

In one embodiment, the method is applied to a membrane electrode assembly for PEM water electrolysis. In PEM electrolysis, a proton-exchange membrane made of PFSA (perfluorosulfonic acid) is used. The PFSA membrane is a particularly important element for the functioning of the membrane electrode assembly and hence of an electrolysis cell. The membrane is coated on the anode side and on the cathode side with a respective catalyst material, preferably a thin layer of iridium is applied on the anode side and a thin layer of platinum on the cathode side. Applications of the recycling method of the invention in membrane electrode assemblies of different electrolysis systems, for example alkaline electrolysis, are advantageously possible.

The exemplary embodiments elucidated hereinbelow represent preferred embodiments of the invention. The features and combinations of features specified above in the description and also the features and combinations of features mentioned in the following description of exemplary embodiments and/or shown in the figures alone are usable not only in the respectively specified combination but in other combinations too. Thus, executions are also encompassed by the invention or are to be regarded as disclosed that are not explicitly shown and elucidated in the figures but arise, and are producible, from the elucidated embodiments through separate combinations of features. The features, functions and/or effects described with reference to the exemplary embodiments can each per se represent individual features, functions and/or effects of the invention that are to be considered independently of one another and that each also develop the invention independently of one another. The exemplary embodiments are therefore intended also to encompass combinations other than those in the elucidated embodiments. The described embodiments may in addition also be supplemented by further of the already described features, functions and/or effects of the invention.

### BRIEF DESCRIPTION OF THE FIGURES

In the figures, identical reference signs denote identical features or functions.

In the figures:

FIG. 1 shows a schematic sectional view through an electrolysis cell having a membrane electrode assembly for the electrolysis of water;

FIG. 2 shows a membrane electrode assembly;

FIG. 3 shows a schematic representation of a sequence of events for the method for the recovery of catalyst material of the membrane electrode assembly.

### DETAILED DESCRIPTION

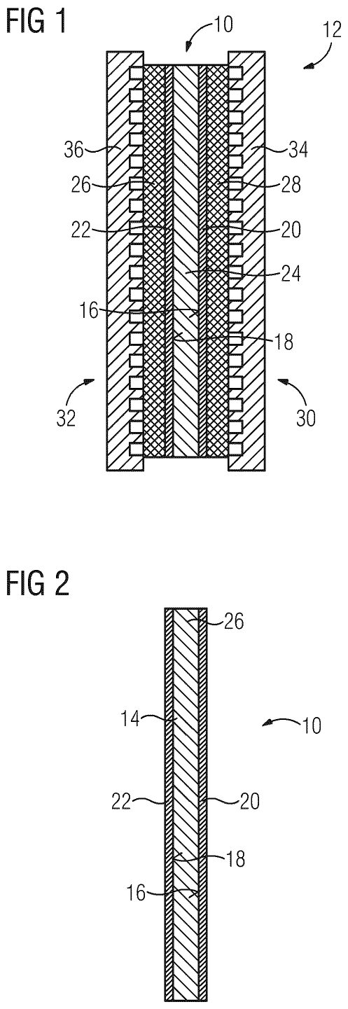

FIG. 1 shows a schematic sectional view of an electrolysis cell 12 having a membrane electrode assembly 10. In the present case, the membrane electrode assembly 10 has a membrane 24 having two surfaces 16, 18 that face away from one another and on which a respective catalyst material 20, 22 is arranged. The catalyst material 20, 22 in turn contacts a respective gas diffusion layer that is formed by a respective nonwoven material 26, 28 and that in turn contacts a respective contact plate 34, 36 on the opposite side. This forms an anode region 30 and a cathode region 32. The contact plates 34, 36 and also the gas diffusion layers are designed to be electrically conductive, thus creating an electrical contact between the respective catalyst materials 20, 22 and the corresponding contact plate 34, 36. The contact plates 34, 36 further have flow channels that are not described, via which on the one hand water or electrolyte can be supplied to the electrolysis cell 12 and on the other hand electrolysis products, namely hydrogen and oxygen, can be discharged.

The membrane electrode assembly 10 is depicted in FIG. 2 as a separate component. In addition to a membrane 26, the membrane electrode assembly 10 comprises the layers of catalyst material 20, 22. The membrane electrode assembly 10 may be produced as a component that can be handled individually, making it possible to handle the membrane electrode assembly 10 in a simple manner in the process for producing the electrolysis cell 12.

The membrane electrode assembly 10 comprises at least the anode-side and the cathode-side catalyst layer, which are usually connected to the membrane 24 to form a single component. The respective chemical reactions take place in the catalyst layers, it being possible for electrons to be conducted away to the contact plates 34, 36 via the catalyst and any support structure that is electrically conductive. It is therefore advantageous when the respective layer of catalyst material 20, 22 has the best possible electrical conductivity and catalytic capability. In addition, hydroxide ions OH-are generated in an alkaline environment and protons H+are generated in an acidic environment, which migrate through the respective membrane as charge carriers. It is therefore also desirable for the catalyst materials 20, 22 to have a correspondingly good conductivity for the respective ions so that they can readily be transported to the membrane 24 or from the membrane 24 to the respective catalytic centers. Therefore, it is desirable that good ionic bonding of the corresponding catalyst material 20, 22 to the respective surface 16, 18 of the membrane 24 can be provided while at the same time ensuring good electrical conductivity of the catalyst material 20, 22\

For use in an acidic environment, the membrane electrode assembly 10 is specially tailored to a PEM water electrolysis. The membrane 24 is for this purpose produced as a proton-conducting membrane 24. The anode-side catalyst layer comprises iridium as a first catalyst material 20. The cathode-side catalyst layer comprises platinum as a second catalyst material 22. The iridium is here applied to the first surface 16 of the membrane 24 and the platinum to the second surface 18 of the membrane 24 on the opposite side. The membrane 24 acts here as substrate 14.

When recycling or reprocessing a membrane electrode assembly 10 or when producing one anew, an initial step in the production of the membrane electrode assembly 10 is providing a membrane 24 as substrate 14, which undergoes coating. The membrane 24 comprises the surface 16 and the second surface 18 facing away from the first surface 16. For the purpose of coating with the respective catalyst materials 20, 22, a coating tool not shown in more detail is provided. The catalyst materials 20, 22 are provided in the present case in paste form, in particular as a pasty compound, so that they can be readily and intimately applied to the respective surface 16, 18 using the coating tool. It is possible here for particles of the respective catalyst material 20, 22 to be dissolved and mixed only with an ionomer in a highly viscous solvent. The production of the catalyst paste is not shown in more detail in the figures. Conventional methods for mixing substances can however be used for this purpose. Unlike in the prior art, this method does not however require the addition of a polymeric binder or nonionic binder. The viscosity of the paste can be adjusted via the ionomer proportion in the solvent such that it is possible to use conventional industrial coating methods for electrode pastes. For example, knife coating or dip coating can thus alternatively also be envisaged.

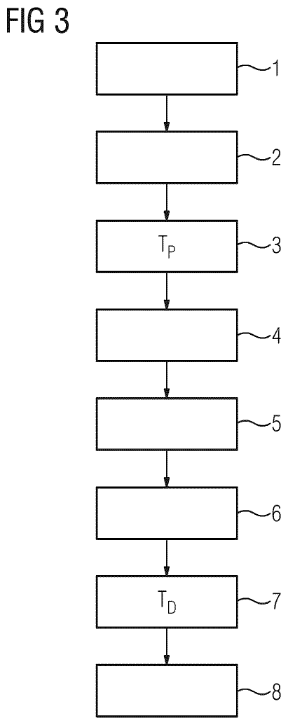

In the case of a used membrane electrode assembly 10, it is economically and environmentally advantageous to recover the valuable metallic catalyst material 20, 22 in a recycling process. For this, the membrane electrode assembly 10 is removed from the electrolysis cell 12 and provided for the recycling process proposed herein in a method step 1. The providing step 1 and the further steps in the method for recovering catalyst material 20, 22 from the membrane electrode assembly are depicted schematically in the flow chart in FIG. 3.

In a method step 2, there first takes place a mechanical comminution 2 of a used membrane electrode assembly 10 to a predetermined degree of comminution. The economic and technical service life of the ion-conducting membrane 24 is limited by various influencing factors. For instance, degradation effects on the membrane 24 have been described that damage the membrane material and impair the function.

Comminution is followed in a method step 3 by the performance of a pyrolysis. The thermal treatment of the comminuted membrane electrode assembly 10 is carried out in an appropriate pyrolysis reactor at a pyrolysis temperature Tp of 600° C. to 1000° C. In the pyrolysis, various thermochemical transformation processes occur in which organic compounds are cleaved at high temperatures and largely with the exclusion of oxygen. The high temperatures result in the cleavage of some chemical bonds in the starting materials, with the oxygen deficit preventing complete combustion. A wide range of products is formed. The residue obtained in method step 3 is a solid pyrolysis product, an ash, that is present in a corresponding granularity or particle size and comprises the metallic catalyst material 20, 22. Present in the ash is a mixture of the catalyst material 20 used on the anode side and the catalyst material 22 used on the cathode side. In the example described here, iridium is the anode-side catalyst material 20 and platinum the cathode-side catalyst material 22.

In the present method it is preferable to use higher pyrolysis temperatures Tp within a range between 600° C. and 1000°° C. for the pyrolytic cleavage of the comminuted membrane electrode unit 10. In the pyrolysis, the membrane 24 preferably passes into the gaseous state completely such that there are no hydrocarbon residues remaining in the solid pyrolysis product, the ash, but instead essentially the metallic constituents of the catalyst material 20, 22.

In method step 4 there now follows a dissolution in aqua regia of the solid pyrolysis products, the ash residue, resulting in the formation of a solution. Aqua regia consists of a mixture of hydrochloric acid HCl and nitric acid HNO3 in a ratio of 3:1. The procedure for the process of the invention essentially differentiates here between catalyst material 20, the iridium, that is insoluble in aqua regia and catalyst material 22, the platinum, that dissolves in aqua regia, and successively separates each of these constituents in just two subsequent steps.

In method step 5 the solution is first heated to 100° C. to 110°° C., resulting in the thermal expulsion of the nitrates from the solution. This step 5 thus comprises a removal of precious metal nitrates, in particular platinum nitrates, and a reprocessing of the catalyst material 22 that has dissolved in the aqua regia and that had been used on the cathode side of the membrane electrode assembly 10 and been applied to the originally intact membrane 24. These are precious metals soluble in aqua regia, such as preferably platinum or binary platinum alloys, for example nickel-platinum, that are used as second catalyst material 22. Thus, the solution left behind after this process step 5 advantageously contains the metallic first catalyst material 20 insoluble in aqua regia that had been used on the anode side of the membrane electrode assembly, for example iridium.

This solid constituent containing a high proportion of iridium is now in method step 6, a filtration step, very advantageously and easily removed, and thus separated, by filtering the insoluble residue. This provides an insoluble residue in which high-value metallic catalyst material 20, namely iridium, already predominates.

As a further method step 7, the residue is finally dried at a drying temperature TD for a drying time such that all liquid constituents and any gaseous constituents still present in the residue are removed or thermally expelled. The drying temperature TD can be 60°° C. to 80° C. To shorten the drying time, higher drying temperatures TD of above 80° C. can also be used. A solid residue is now advantageously recovered that comprises the insoluble metallic catalyst material 20, namely iridium, in high purity or already consists predominantly thereof. The iridium is present in the form of iridium black having a purity of over 90%, in particular of 97% to 99.5%. The iridium, as the precious metal first catalyst material 20, can be purified directly and supplied for reuse in a membrane electrode assembly 10, for instance applied onto a new membrane 24 as anode-side catalyst material 20. A grinding process for the recovered iridium black as first catalyst material 20 can if required be provided in a further process step 8, in order to achieve a desired particle size for use of the iridium and application onto a provided membrane 24. The recovered iridium is in this process adjusted to a grinding level or median particle size of 20 μm to 50 μm. The method has been found to recover iridium in a yield substantially greater than 80%. Yields of over 90%, for example between 92% and 96%, based on the original amount of iridium, have been achieved. This makes the process particularly and advantageously applicable for efficient recovery of iridium and platinum from used membrane electrode assemblies 10 from PEM water electrolysis with a proton-exchange membrane made of PFSA (perfluorosulfonic acid).

As can be seen from the exemplary embodiment according to FIG. 3 in particular, the method according to the invention has been found to be particularly well suited to the recovery of the valuable precious metal catalyst material 20, 22 from a used membrane electrode assembly 10 in a recycling process with high purity and high recovery yield.

The end result is that a new membrane electrode assembly 10 can be produced in this way with the separation method of the invention, wherein the iridium and the platinum are reused. From a process perspective, the manageable number of process steps in the recovery of pure iridium gives rise to much lower costs. In particular, iridium black is recovered directly, which means there is no need for complicated and laborious transformation and reprocessing steps.

The present invention permits a simplified and very efficient recovery of high-quality and high-purity iridium black catalysts from used materials of a membrane electrode assembly 10 from PEM water electrolysis. Important advantages can be seen in the cost saving in the separation process, cost saving in catalyst synthesis, energy saving across the entire process chain of the method, shorter process time, and high availability of the method. The invention permits a cost-effective and easy recovery of iridium black that is scalable to industrial scale. This makes the precious metals iridium and platinum available again in the production process for new membrane electrode assemblies 10, in maximal yield and quality.

The exemplary embodiments of the invention serve exclusively to elucidate the invention and are not intended to restrict it.

1. A method for recovering catalyst material from a membrane electrode assembly from water electrolysis, comprising:
providing a membrane electrode assembly comprising a membrane coated with a metallic catalyst material;
comminuting the membrane electrode assembly;
pyrolytically breaking down the comminuted membrane electrode assembly to obtain a solid pyrolysis product as residue;
dissolving the solid pyrolysis product in a mixture of concentrated hydrochloric acid and concentrated nitric acid to create a solution;
removing nitrates by heating the solution to 100° C. to 110° C.;
filtering an insoluble residue; and,
drying the insoluble residue at a drying temperature (TD) to recover the metallic catalyst material.

2. The method as claimed in claim 1, in which the insoluble residue is ground in a grinding process such that a median particle size of 10 μm to 80 μm, in particular of 20 μm to 50 μm, is achieved.

3. The method as claimed in claim 1, wherein the pyrolysis is carried out at a pyrolysis temperature (TP) of from 600° C. to 1000° C., in particular from 700°° C. to 900° C.

4. The method as claimed in claim 1, in which the solid pyrolysis product is dissolved at a temperature of from 70° C. to 90° C., in particular at a temperature of 80° C., with the temperature being maintained during dissolution for between 3 h to 5 h, in particular for 4 h.

5. The method as claimed in claim 1, in which the heating expels and removes dissolved metallic constituents, with the insoluble residue being obtained.

6. The method as claimed in claim 5, in which platinum (Pt) is removed and recovered as dissolved metal constituent.

7. The method as claimed in claim 1, in which iridium (Ir) is recovered as metallic catalyst material.

8. The method as claimed in claim 7, in which iridium (Ir) is recovered in a form of solid iridium black, an iridium purity of 97% to 99.5%, in particular of 98% to 99.3%, being achieved.

9. The method as claimed in claim 8, in which the a yield of recovered iridium black (Ir) of greater than 80%, in particular of between 92% and 96%, based on an amount of iridium originally present, is achieved.

10. The method as claimed in claim 1, applied to a membrane electrode assembly for PEM water electrolysis.
